(19) United States
(12) Patent Application Publication
(10) Pub. No.: US 2026/0302614 A1
(43) Pub. Date: Oct. 1, 2026

(54) ANTENNA DEVICE AND BEAM CONTROL METHOD

(71) Applicants: Beijing BOE Technology Development Co., Ltd., Beijing (CN); BOE TECHNOLOGY GROUP CO., LTD., Beijing (CN)

(72) Inventors: Jian ZHOU, Beijing (CN); Shuaipeng TAO, Beijing (CN)

(21) Appl. No.: 18/880,363

(22) PCT Filed: May 16, 2023
(86) PCT No.: PCT/CN2023/094495

§ 371 Date: Dec. 31, 2024

(51) Int. Cl. H01Q 3/36; H01Q 13/10

(52) U.S. Cl. CPC H01Q 3/36; H01Q 13/10

(57) ABSTRACT

An antenna device includes antenna units arranged side by side in a second direction. Each antenna unit includes a waveguide structure and a radiation structure. The radiation structure includes a first dielectric substrate, a first electrode layer having therein slit openings arranged side by side along a first direction, a first adjustable dielectric layer, a second electrode layer comprising patch electrodes spaced apart from each other, and a second dielectric substrate which are arranged sequentially. The first dielectric substrate is on a waveguide cavity of the waveguide structure. Orthogonal projections of each patch electrode and one of the slit openings on the first dielectric substrate at least partially overlap with each other. The antenna device further includes a feed structure including at least one first feed port and plural second feed ports, each second feed port being electrically connected to the waveguide structure of one of the antenna units.

### CROSS-REFERENCE TO RELATED APPLICATIONS

This is a National Phase application filed under 35 U.S.C. 371 as a national stage of PCT/CN2023/094495 filed on May 16, 2023, the entire content of which is incorporated herein by reference.

### TECHNICAL FIELD

The present disclosure relates to the field of communication technology, and in particular, to an antenna device and a beam control method.

### BACKGROUND

An operation performance of an antenna as a terminal device of each of most wireless communication systems is crucial to the overall performance of the system. With the development of science and technology, the requirements on the performance of the antenna are higher and higher. In addition to the high requirements of conventional indicators such as conventional gain, polarization, etc., there are many cases where the antenna is required to have characteristics such as low profile, light weight, easy conformality, etc. Although a reflector antenna, a phased array antenna, a lens antenna, and the like can realize a high gain, they have respective obvious disadvantages. For example, the reflector antenna needs to be provided with a space illumination source, and thus has a greatly increased section. The phased array antenna has an extremely complex feed network, and thus is difficult to be designed and has a high cost. The lens antenna itself has a high profile, which is further increased by the lens antenna further including an illumination source. A holographic antenna, which is a high-gain antenna, can meet all of the requirements of low profile, light weight, and the like, and thus is very suitable for the current trend of application and has great development potential.

The concept of the holographic antenna is derived from the principle of optical holography, which is that an interference surface is formed by interference of a target wave and a reference wave, and then the interference surface is irradiated by the reference wave to perform inversion to obtain the target wave. A holographic antenna system only includes a holographic surface and a feed source, and thus has a very simple structure. The feed source is generally a horn antenna, a monopole antenna, or a slot antenna, and does not need a complex feed network.

### SUMMARY

To solve at least one of technical problems existing in the prior art, the present disclosure provides an antenna device and a beam control method.

In a first aspect, embodiments of the present disclosure provide an antenna device, which includes a plurality of antenna units arranged side by side in a second direction, wherein each of the plurality of antenna units includes a waveguide structure and a radiation structure; the radiation structure includes a first dielectric substrate and a second dielectric substrate which are opposite to each other, a first electrode layer arranged on a side of the first dielectric substrate proximal to the second dielectric substrate, a second electrode layer arranged on a side of the second dielectric substrate proximal to the first dielectric substrate, and a first adjustable dielectric layer arranged between the first dielectric substrate and the second dielectric substrate; the first dielectric substrate is arranged on a waveguide cavity of the waveguide structure; the first electrode layer has therein a plurality of slit openings arranged side by side along a first direction, and the second electrode layer includes a plurality of patch electrodes spaced apart from each other; an orthogonal projection of each of the plurality of patch electrodes on the first dielectric substrate at least partially overlaps with an orthogonal projection of one of the plurality of slit openings on the first dielectric substrate; and wherein the antenna device further includes a feed structure, the feed structure includes at least one first feed port and a plurality of second feed ports, and each of the plurality of second feed ports is electrically connected to the waveguide structure of one of the plurality of antenna units.

In an embodiment, the feed structure includes a main feed channel and a plurality of branch feed channels, each of the main feed channel and the plurality of branch feed channels has a first terminal and a second terminal, the first terminal of the main feed channel serves as the first feed port, first terminals of the branch feed channels are all connected to the second terminal of the main feed channel, and second terminals of the branch feed channels serve as the second feed ports, respectively.

In an embodiment, the antenna device further includes a plurality of phase adjustment structures, wherein each of the branch feed channels is electrically connected to the waveguide structure of one of the antenna units through one of the phase adjustment structures.

In an embodiment, each of the phase adjustment structures includes a liquid crystal phase shifter.

In an embodiment, at least some of the branch feed channels have different lengths.

In an embodiment, every adjacent two of the branch feed channels are grouped as one group, and the two branch feed channels in each group have different lengths.

In an embodiment, the lengths of the two branch feed channels in each group are set such that electromagnetic waves fed from the two branch feed channels into the respective waveguide structures have a phase difference of 180°.

In an embodiment, the plurality of branch feed channels have a same length, and at least some of the plurality of branch feed channels are filled with different media.

In an embodiment, every adjacent two of the branch feed channels are grouped as one group, and the two branch feed channels in each group are filled with different media.

In an embodiment, the media filled in the two branch feed channels in each group are provided such that electromagnetic waves fed from the two branch feed channels into the respective waveguide structures have a phase difference of 180°.

In an embodiment, the plurality of second feed ports of the feed structure feed electromagnetic waves, which have different phases from each other, into the respective waveguide structures.

In an embodiment, any adjacent two of the second feed ports feed electromagnetic waves, which have a phase difference of 180°, into the respective waveguide structures.

In an embodiment, the feed structure includes a plurality of feed channels, each of which has a first terminal and a second terminal, the first terminal of one of the feed channels serves as one of the at least one first feed port of the feed structure, and the second terminal of each feed channel serves as one of the second feed ports of the feed structure.

In an embodiment, the first electrode layer is connected to a first bias voltage line, each of the patch electrodes is connected to a second bias voltage line, and the patch electrodes are connected to separate second bias voltage lines.

In an embodiment, the slit openings of the antenna units are arranged in a one-to-one correspondence; the first electrode layer is connected to a first bias voltage line, each of the patch electrodes is connected to a second bias voltage line; and the patch electrodes arranged side by side along the second direction are connected to a same second bias voltage line.

In an embodiment, the antenna device further includes a driver chip, wherein both each first bias voltage line and each second bias voltage line are electrically connected to the driver chip.

In an embodiment, a width of a central region of each slit opening is not greater than a width of each of both end regions of the slit opening.

In an embodiment, the width of each of the both end regions of the slit opening is decreased in a direction toward the central region.

In a second aspect, embodiments of the present disclosure provide a beam control method for an antenna device, where the antenna device is the antenna according to any one of the foregoing embodiments, and the beam control method includes:
obtaining excitation amplitude values of the slit openings through an amplitude sampling function, according to positions of the slit openings of each antenna unit, a pitching angle and an azimuth angle of a target pointing direction, and target frequencies of electromagnetic waves fed from the second feed ports of the feed structure into the waveguide structures of the respective antenna units;
discretizing the excitation amplitude values of the slit openings to obtain discretization results; and
controlling radiation elements according to the discretization results so as to control a turn-on state and a turn-off state of the slit openings.

In an embodiment, the feed structure includes a plurality of feed channels, each of which has a first terminal and a second terminal, the first terminal of one of the feed channels serves as one of the at least one first feed port of the feed structure, and the second terminal of each feed channel serves as one of the second feed ports of the feed structure; and
at least some of the feed channels feed electromagnetic waves, which have different frequencies, into the waveguide structures of the antenna units connected to the at least some of the feed channels.

### BRIEF DESCRIPTION OF THE DRAWINGS

FIG. 1 is a schematic diagram illustrating a structure of an antenna device according to an embodiment of the present disclosure.

FIG. 2 is a sectional view illustrating an antenna unit according to an embodiment of the present disclosure.

FIG. 3 is a top view illustrating a first electrode layer according to an embodiment of the present disclosure.

FIG. 4 is a graph illustrating frequency-energy curves of radiation energy of a radiation element based on rotation of liquid crystal molecules, according to an embodiment of the present disclosure.

FIG. 5 is a schematic diagram illustrating a slit opening according to an embodiment of the present disclosure.

FIG. 6 is a schematic diagram illustrating another structure of an antenna device according to an embodiment of the present disclosure.

FIG. 7 is a simulation diagram illustrating a wavefront control distribution and a far field result of an antenna device at a beam pointing direction of (0°, 0°), in a first example according to an embodiment of the present disclosure.

FIG. 8 is a simulation diagram illustrating a wavefront control distribution and a far field result of the antenna device at a beam pointing direction of (45°, 30°), in the first example according to the embodiment of the present disclosure.

FIG. 9 is a simulation diagram illustrating a wavefront control distribution and a far field result of the antenna device at a beam pointing direction of (135°, 30°), in the first example according to the embodiment of the present disclosure.

FIG. 10 is a simulation diagram illustrating a wavefront control distribution and a far field result of the antenna device at a beam pointing direction of (225°, 30°), in the first example according to the embodiment of the present disclosure.

FIG. 11 is a simulation diagram illustrating a wavefront sampling distribution and a far field result of the antenna device at a beam pointing direction of (315°, 45°), in the first example according to the embodiment of the present disclosure.

FIG. 12 is a flowchart illustrating a beam control method for an antenna device according to an embodiment of the present disclosure.

FIG. 13 is a schematic diagram illustrating a structure of an antenna device in a second example according to an embodiment of the present disclosure.

FIG. 14 is a sectional view illustrating a phase adjustment structure, which is a liquid crystal phase shifter, according to an embodiment of the present disclosure.

FIG. 15 is a schematic diagram illustrating a second directional beam control and a first directional beam control implemented by the antenna device shown in FIG. 13.

FIG. 16 is a simulation diagram illustrating a far field result of the antenna device shown in FIG. 13.

FIG. 17 is a schematic diagram illustrating another structure of the antenna device in the second example according to the embodiment of the present disclosure.

FIG. 18 is a simulation diagram illustrating that a side lobe is greatly suppressed at a large angle position in an antenna device in which an initialized phase is differentiated, as compared with the case of a same initial phase.

FIG. 19 is a schematic diagram illustrating distributions of wavefront sampling in the case of a same initial phase and the case of different initial phases.

FIG. 20 is a schematic diagram illustrating a structure of an antenna device in a third example according to an embodiment of the present disclosure.

FIG. 21 is a schematic diagram illustrating a structure of an antenna device in a fifth example according to an embodiment of the present disclosure.

FIG. 22 is a diagram illustrating a simulation effect of side lobe suppression of the antenna device shown in FIG. 21.

FIG. 23 is a diagram illustrating a multi-user interaction effect of an antenna device in a sixth example according to an embodiment of the present disclosure.

FIG. 24 is a diagram illustrating a distribution of space frequencies of the antenna device shown in FIG. 23 in a case where different feed channels correspond to different pointing directions and different frequencies.

FIG. 25 is a diagram illustrating an interaction effect between an antenna device according to an embodiment of the present disclosure and a plurality of users when the antenna device implements a first direction scanning.

FIG. 26 is a diagram illustrating a wavefront distribution and a far field result of a single beam scanning in a first direction implemented by an antenna device according to an embodiment of the present disclosure.

FIG. 27 is a diagram illustrating a wavefront distribution and a far field result of a multi-beam scanning in the first direction implemented by an antenna device according to an embodiment of the present disclosure.

FIG. 28 is a diagram illustrating an interaction effect between an antenna device according to an embodiment of the present disclosure and a plurality of users when the antenna device implements a second direction scanning.

FIG. 29 is a diagram illustrating a wavefront distribution and a far field result of a single beam scanning in a second direction implemented by an antenna device according to an embodiment of the present disclosure.

FIG. 30 is a diagram illustrating a wavefront distribution and a far field result of a multi-beam scanning in the second direction implemented by an antenna device according to an embodiment of the present disclosure.

FIG. 31 is a diagram illustrating an interaction effect between an antenna device according to an embodiment of the present disclosure and a plurality of users when the antenna device implements a scanning in a plane defined by the first direction and the second direction.

FIG. 32 is a diagram illustrating a wavefront distribution and a far field result of a scanning in a plane defined by the first direction and the second direction implemented by an antenna device according to an embodiment of the present disclosure.

### DETAILED DESCRIPTION OF EMBODIMENTS

To make technical solutions of the present disclosure better understood by one of ordinary skill in the art, the present disclosure will be further described in detail with reference to the accompanying drawings and exemplary embodiments below.

Unless defined otherwise, technical or scientific terms used herein shall have the ordinary meaning as understood by one of ordinary skill in the art to which the present disclosure belongs. The use of “first”, “second”, and the like in the present disclosure is not intended to indicate any order, quantity, or importance, but rather is for distinguishing one element from another. Further, the use of the terms “a”, “an”, “the”, or the like does not denote a limitation of quantity, but rather denotes the presence of at least one. The term of “comprising”, “including”, or the like, means that the element or item preceding the term contains the element or item listed after the term and its equivalent, but does not exclude the presence of other elements or items. The term “connected”, “coupled”, or the like is not limited to physical or mechanical connections, but may include electrical connections, whether direct or indirect. The terms “upper”, “lower”, “left”, “right”, and the like are used only for indicating relative positional relationships, and when the absolute position of an object being described is changed, the relative positional relationships may also be changed accordingly.

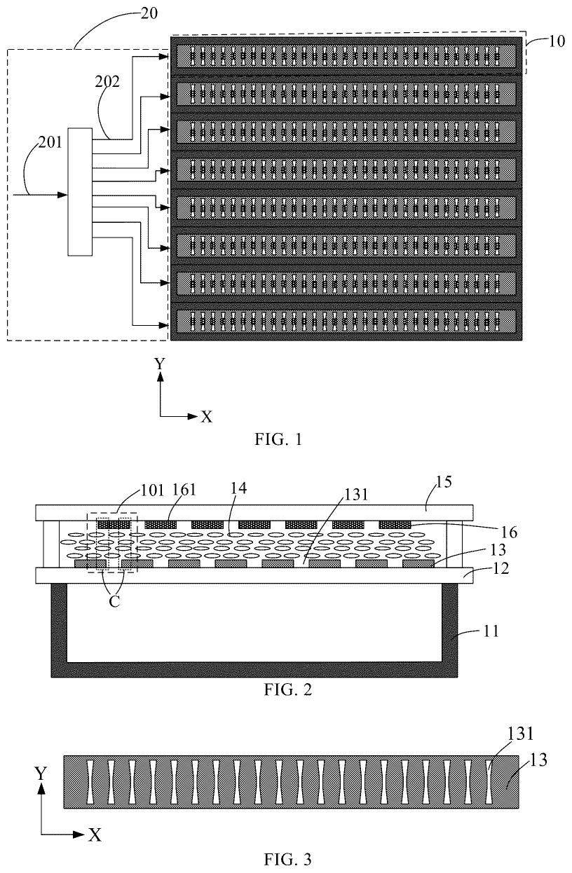

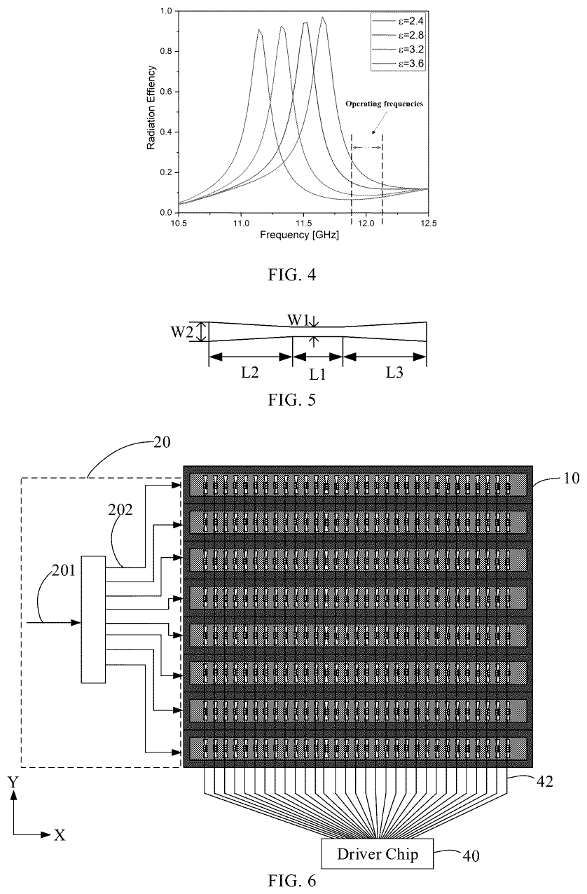

In a first aspect, FIG. 1 is a schematic diagram illustrating a structure of an antenna device according to an embodiment of the present disclosure; FIG. 2 is a sectional view illustrating an antenna unit according to an embodiment of the present disclosure; and FIG. 3 is a top view illustrating a first electrode layer according to an embodiment of the present disclosure. As shown in FIGS. 1 to 3, the antenna device according to the present embodiment includes a plurality of antenna units 10 arranged side by side along a second direction Y and a feed structure 20. Each antenna unit according to an embodiment of the present disclosure may be a holographic antenna. Each antenna unit 10 includes a waveguide structure 11 and a radiation structure. The radiation structure includes a first dielectric substrate 12 and a second dielectric substrate 15 which are arranged opposite to each other, a first electrode layer 13 arranged on a side of the first dielectric substrate 12 proximal to the second dielectric substrate 15, a second electrode layer 16 arranged on a side of the second dielectric substrate 15 proximal to the first dielectric substrate 12, and a first adjustable dielectric layer 14 arranged between the first electrode layer 13 and the second electrode layer 16. The first dielectric substrate 12 is located on a waveguide cavity of the waveguide structure 11, and the first electrode layer 13 has a plurality of slit openings 131 arranged side by side in a first direction X. The second electrode layer 16 includes a plurality of patch electrodes 161 arranged side by side and spaced apart from each other along the first direction X, and an orthogonal projection of each of the plurality of patch electrodes 161 on the first dielectric substrate 12 at least partially overlaps with an orthogonal projection of one of the slit openings 131 on the first dielectric substrate 12. In the present embodiment, as an example, the plurality of patch electrodes 161 are arranged in one-to-one correspondence with the plurality of slit openings 131. The feed structure 20 includes at least one first feed port and a plurality of second feed ports, and each of the plurality of second feed ports is electrically connected to the waveguide structure 11 of one of the antenna units 10. The feed structure 20 is configured to feed signals to the waveguide structures 11 of the antenna units 10.

It should be noted that in an embodiment of the present disclosure, the first adjustable dielectric layer 14 includes, but is not limited to, a liquid crystal layer, and a case where the first adjustable dielectric layer 14 is the liquid crystal layer is taken as an example. In an embodiment of the present disclosure, the radiation structure is divided into a plurality of radiation elements 101 that are arranged side by side along the first direction, and each radiation element 101 includes a patch electrode 161 and a slit opening 131 that are arranged corresponding to each other. An orthogonal projection of a peripheral region of the slit opening 131 of each radiation element 101 on the first dielectric substrate 12 and an orthogonal projection of the patch electrode 161 of the radiation element 101 on the first dielectric substrate 12 have an overlapping portion, such that the peripheral region of the slit opening 131 of each radiation element 101 and the patch electrode 161 of the radiation element 101 form an adjustable capacitor C. A bias voltage may be applied across the first electrode layer 13 and the patch electrodes 161 to change a dielectric constant of the first adjustable dielectric layer 14, thereby tuning the energy of an electromagnetic wave radiated from each radiation element 101. Further, referring to FIG. 4, by applying a bias voltage across the first electrode layer 13 and the patch electrodes 161 to change the dielectric constant of the first adjustable dielectric layer 14, positions of resonance peaks of electromagnetic waves fed from the waveguide structure 11 to the radiation elements 101, i.e., positions of resonance peaks of the electromagnetic waves in the radiation elements 101 under different dielectric constants, are changed, thereby tuning the energies of the electromagnetic waves at different frequencies. A bias voltage applied to the first electrode layer 13 includes, but is not limited to, a ground voltage, and for convenience of control, a case where the ground voltage is applied to the first electrode layer 13 is taken as an example in an embodiment of the present disclosure.

In addition, it should be understood that whether a radiation element 101 can radiate outward an electromagnetic wave depends on a rotation state of the liquid crystal molecules of the first adjustable dielectric layer 14. There being no electromagnetic wave radiated from radiation element 101 is equivalent to a corresponding slit opening 131 being in a turn-off state, and there being an electromagnetic wave radiated from radiation element 101 is equivalent to the corresponding slit opening 131 being in a turn-on state. Therefore, the turn-on state and the turn-off state of a slit opening 131 mentioned in the following description do not refer to a macroscopic state of the slit opening, but characterize whether a corresponding radiation element 101 can radiate outward an electromagnetic wave.

In the antenna device according to an embodiment of the present disclosure, the feed structure 20 feeds signals to the antenna units 10, and a bias voltage applied to the patch electrode 161 of each radiation element 101 is controlled, to control the rotation state of the liquid crystal molecules of the first adjustable dielectric layer 14, thereby controlling a radiation direction of the electromagnetic wave radiated from the slit opening 131, and realizing beam controlling in the entire space.

Specifically, one end of a bottom wall of the waveguide cavity of the waveguide structure 11 of each antenna unit 10 is connected to the feed structure 20, and the other end thereof is connected to a wave-absorbing load (not shown). For each antenna unit 10, an electromagnetic wave is fed from the second feed port to the one end of the waveguide structure 11 of the antenna unit 10 to enter into the waveguide cavity, a part of the electromagnetic wave couples energy outward according to a radiation condition of the radiation element 101, and a part of the electromagnetic wave is absorbed by the wave-absorbing load at the other end of the waveguide structure 11, such that the electromagnetic wave in the waveguide cavity is prevented from being influenced by reflection. The wave-absorbing load includes, but is not limited to, a waveguide tube.

In some examples, the waveguide cavity of the waveguide structure 11 may be filled with a material of polymer, which has a low loss, to achieve the effect of a slow wave waveguide. Alternatively, an air medium may also be filled in the waveguide cavity.

In some examples, a lengthwise direction of each slit opening 131 in the first electrode layer and an extending direction of a microstrip line (i.e., a direction in which a microstrip line extends) are perpendicular to each other. In an embodiment of the present disclosure, the extending direction of the microstrip line is the first direction X, and the lengthwise direction of each slit opening 131 is the second direction Y.

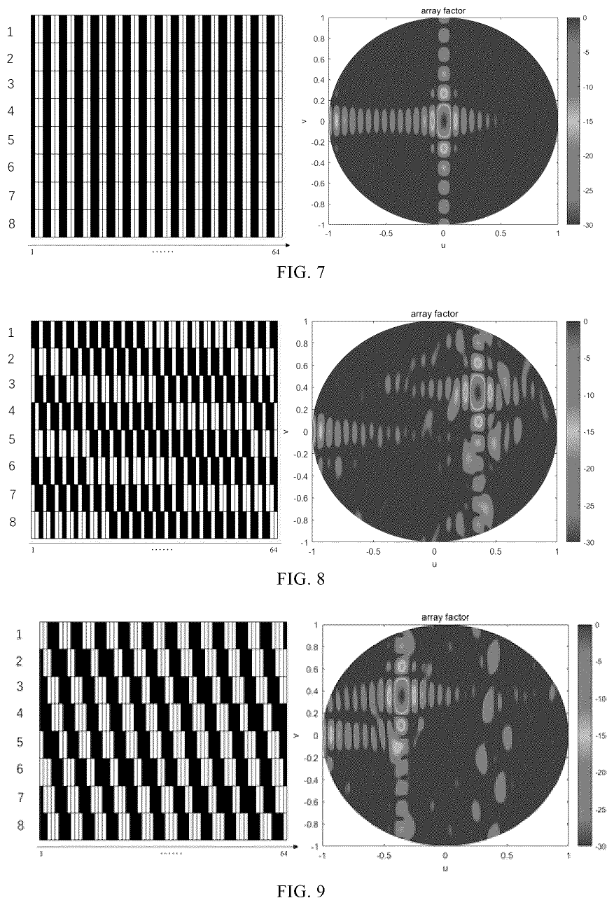

Further, in an embodiment of the present disclosure, a width of a central region of a slit opening 131 is not greater than a width of each of both end regions of the slit opening 131. For example, the width of the central region of the slit opening 131 is less than the width of each of both end regions, and the width of each of both end regions becomes smaller towards the central region, i.e., the width of each of both end regions is gradually changed. The width and a length of the central region of the slit opening 131 are W1 and L1, respectively, where 0.02 mm≤W1≤0.5 mm, and 0<L1≤0.5 mm; the lengths of both end regions of the slit opening are L2 and L3, respectively, and the maximum width of each of the both end regions is W2, where L2=L3, 0.75 mm≤L2≤2.5 mm, and 0.12 mm≤W2≤0.5 mm, as shown in FIG. 5.

In an example, the width of the central region of the slit opening 131 is 20 μm, the length of the central region is 0.4 mm, the lengths of both end regions of the slit opening 131 are equal to each other and each is 2 mm, and the maximum width of each of both end regions of the slit opening 131 is 0.12 mm. Each patch electrode 142 has a width of 0.3 mm and a length of 0.5 mm. The number of the slit openings 131 in one first electrode layer 13 is 64, i.e., the number of the radiation elements of each antenna unit 10 is 64. In the following specific examples, simulations are performed by taking such parameters as an example, but it should be understood that the scope of an embodiment of the present disclosure is not limited by such parameters.

Further, the antenna device further includes a first bias voltage line and a second bias voltage line 42, as shown in FIG. 6. The first electrode layer is electrically connected to the first bias voltage line, and the patch electrodes 161 are electrically connected to the second bias voltage line 42. The first electrode layer is supplied with a first bias voltage through the first bias voltage line, and the patch electrodes 161 are supplied with a second bias voltage through the second bias voltage line 42, so as to control the rotation state of the liquid crystal molecules of the first adjustable dielectric layer 14 in each radiation element 101, thereby realizing the control of the turn-on state and the turn-off state of each radiation element 101, and thus realizing the control of the turn-on state and the turn-off state of each slit opening 131.

Further, FIG. 6 is a schematic diagram illustrating another structure of an antenna device according to an embodiment of the present disclosure. As shown in FIG. 6, for each antenna unit 10, the first electrode layer 13 is electrically connected to one first bias voltage line, whereas the patch electrodes 161 of the radiation elements are connected to separate second bias voltage lines 42, respectively, such that the radiation elements 101 can be controlled independently. In some examples, both the first bias voltage line and the second bias voltage lines 42 may be disposed on the second dielectric substrate so as to be connected to a driver chip 40 conveniently. In this case, the first electrode layer 13 may be electrically connected to the first bias voltage line through a conductive gold ball.

In an example, the patch electrodes 161 of each antenna unit 10 of the antenna device are connected to independent (or separate) second bias voltage lines 42, and the driver chip 40 controls a second bias voltage to be loaded on the second bias voltage lines 42, so as to implement beam scanning in the whole space.

In an example, the radiation elements of the antenna units 10 of the antenna device are arranged in a one-to-one correspondence with each other. That is, in the second direction Y, the patch electrodes in the antenna units 10 are arranged in a one-to-one correspondence with each other, and the slit openings therein are arranged in a one-to-one correspondence with each other. In this case, the patch electrodes 161 of the radiation elements 101 arranged side by side in the second direction Y are electrically connected to a same second bias voltage line 42, and the second bias voltage to be applied to the second bias voltage lines 42 is controlled by the driver chip 40, thereby realizing a same switching state of the radiation elements arranged side by side in the second direction Y.

Further, the driver chip 40 according to an embodiment of the present disclosure includes, but is not limited to, a programmable logic device (e.g., field programmable gate array (FPGA)).

In an embodiment of the present disclosure, the feed structure 20 may be a waveguide power divider, a single waveguide structure 11, or a feed structure 20 formed by a plurality of independent feed channels, and the antenna device according to an embodiment of the present disclosure is further described below with reference to a specific structure of the feed structure 20. Each antenna unit 10 of the antenna device may have any one of the above-described structures, and a detailed description of the specific structure of each antenna unit 10 will not be repeated in the following description.

In a first example, as shown in FIGS. 1 to 3, the feed structure 20 of the antenna device in this example adopts a one-to-many power divider. In an embodiment of the present disclosure, the antenna device may include eight antenna units 10 arranged side by side along the second direction Y, and in this case, the feed structure 20 is a one-to-eight power divider, i.e., the feed structure 20 includes one main feed channel 201 and eight branch feed channels 202. Each of the main feed channel 201 and the branch feed channels 202 has a first terminal and a second terminal. The second terminal of the main feed channel 201 is connected to the first terminal of each branch feed channel 202, and the second terminals of the branch feed channels 202 are connected in a one-to-one correspondence with the waveguide structures 11 of the antenna units 10. It will be understood that the first terminal of the main feed channel 201 serves as the first feed port of the feed structure 20, and the second terminals of the branch feed channels 202 serve as the second feed ports of the feed structure 20. On the basis of such a structure, excitation amplitude values of the slit openings 131 of each antenna unit 10 may be obtained by adopting a holographic algorithm and according to an amplitude sampling function, and then a discretization (i.e., binarization) process is performed on the excitation amplitude values of the slit openings 131 to obtain discretization results; and finally, the state of the first adjustable dielectric layer of each radiation element 101 is controlled according to the discretization results, thereby realizing the control of the turn-on state and the turn-off state of the slit openings 131, and realizing different beam pointing directions.

In some examples, the one-to-eight power divider may be specifically a one-to-eight waveguide power divider, and an isolation component is disposed between any adjacent two of the branch feed channels 202. The isolation component may be specifically a conductive through hole disposed between adjacent two of the branch feed channels 202 periodically. The branch feed channels 202 are isolated from each other by providing the isolation component between any adjacent two of the branch feed channels 202, thereby improving an isolation degree of signals. Apparently, the feed structure 20 according to an embodiment of the present disclosure is not limited to the waveguide power divider, and may alternatively be a feed network with another structure.

Next, a beam control method for the antenna device will be described in detail below. Here, the slit openings 131 of the antenna units 10 of the antenna device form a two-dimensional array.

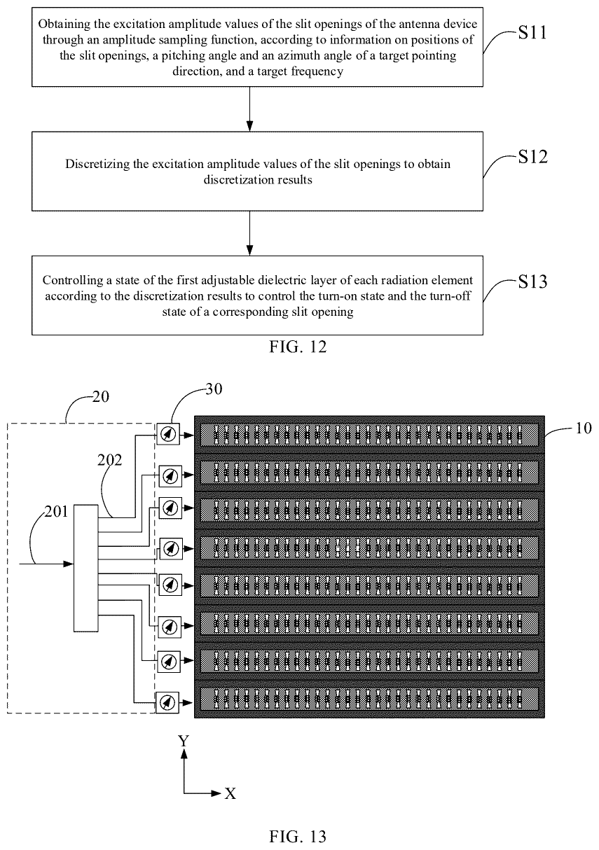

FIG. 12 is a flowchart illustrating a beam control method for an antenna device according to an embodiment of the present disclosure. As shown in FIG. 12, the beam control method according to the present embodiment includes the following steps S11 to S13.

Step S11 includes obtaining the excitation amplitude values of the slit openings 131 of the antenna device through an amplitude sampling function, according to information on positions of the slit openings 131, a pitching angle and an azimuth angle of a target pointing direction, and a target frequency.

In step S11, the information on positions of the slit openings 131 in the two-dimensional array of the antenna device may be stored in advance. The target frequency is 12.1 GHZ, or may be any frequency from 12 GHz to 24 GHz. The pitching angle and the azimuth angle of the target pointing direction are designed to be (0°, 0°), (45°, 30°), (135°, 30°), (225°, 30°), and (315°, 45°), and other angles may be adopted. Based on the holographic principle and according to the amplitude sampling function, the excitation amplitude value of each slit opening 131 is obtained.

Specifically, the holographic principle is as follows: the interference of a reference wave and a target wave is performed, and the resultant interference pattern is used for designing an interference wavefront; and the target wave is obtained through an interaction of the reference wave and the interference wavefront.

A function of the target wave is as follows:

$${Ψ}_{obj} ( \vec{r} ; {θ}_{0} , {φ}_{0} ) = exp ( - i {k}_{0} ( {θ}_{0} , {φ}_{0} ) \cdot \vec{r} ) ,$$

in addition, a function of the reference wave is as follows:

$${Ψ}_{ref} ( \vec{r} ) = exp ( - i {k}_{g} \cdot \vec{r} ) ,$$

where K_{g} is a waveguide wavenumber, k₀ is a wavenumber in the free space, θ₀ is the pitching angle of the target wave beam pointing direction, and φ₀ is the azimuth angle of the target wave beam pointing direction.

A wavefront interference pattern is obtained by using the holographic principle as follows:

$${Ψ}_{intf} = {Ψ}_{obj} {Ψ}_{ref}^{*} ,$$

$${Ψ}_{intf} ( \vec{r} ; {θ}_{0} , {φ}_{0} ) = exp ( - i {k}_{0} ( {θ}_{0} , {φ}_{0} ) \cdot \vec{r} ) exp ( - i {k}_{g} \cdot \vec{r} ) .$$

A vector k_{f} of the target wave and a vector kₛ of the reference wave are defined based on the above formulas, interference of the reference wave with the target wave is performed to result in a transmission coefficient of the interference wavefront, which interacts with the reference wave to finally obtain the target wave.

Based on the above principle, the amplitude sampling function for a two-dimensional antenna design is as follows:

$$m ( \vec{r} ; {θ}_{0} , {φ}_{0} ) = \frac{Re ( {Ψ}_{intf} ( \vec{r} ; {θ}_{0} , {φ}_{0} ) ) + 1}{2} = \frac{cos ( ( {k}_{g} - {k}_{f} ( {θ}_{0} , {φ}_{0} ) ) \cdot \vec{r} ) + 1}{2} ,$$

the excitation amplitude value corresponding to a position of each slit opening 131 may be obtained through the amplitude sampling function.

Step S12 includes discretizing (i.e., performing a discretization process on) the excitation amplitude values of the slit openings 131 to obtain discretization results.

In some examples, step S12 may include discretizing the excitation amplitude value of each slit opening 131, and a discretization threshold is t, where 0<t<1. In a case where the excitation amplitude value m of a slit opening 131 is not less than t, the resultant discretization result M is recorded as 1, and in a case where the excitation amplitude value m of the slit opening 131 is less than t, the resultant discretization result M is recorded as 0.

For example, t=0.5, and the number of the slit openings 131 is 64×8. In a case where the excitation amplitude value m of a slit opening 131 obtained in step S11 is 0.79, the discretization result M of the excitation amplitude value m of the slit opening 131 is recorded as 1. In a case where the excitation amplitude value m of a slit opening 131 is 0.35, the discretization result M of the excitation amplitude value m of the slit opening 131 is recorded as 0. In this way, the discretization results M of the excitation amplitude values m of the 64×8 slit openings 131 can be obtained.

It should be noted that a magnitude of the discretization threshold t needs to be adjusted, and antenna simulation diagrams are obtained through simulating by an electromagnetic software for antennas obtained according to different discretization thresholds t. The antenna simulation diagrams are compared with amplitude-weighted theoretical simulation diagrams of the antennas to find out the desired discretization threshold t. In this way, when the antenna simulation diagrams are closest to the amplitude-weighted theoretical simulation diagrams of the antennas, the discretization threshold t corresponding to the antenna simulation diagrams is taken as the desired discretization threshold t.

Step S13 includes controlling a state of the first adjustable dielectric layer of each radiation element according to the discretization results to control the turn-on state and the turn-off state of a corresponding slit opening 131.

Specifically, for the case where the discretization results M are recorded as 0 or 1 in discretizing the excitation amplitude values m of the slit openings 131 in step S12, in step S13, in the case where the discretization result M is 1, a corresponding radiation element is controlled to be in the turn-on state, such that a corresponding slit opening 131 is in the turn-on state; in the case where the discretization result M is 0, a corresponding radiation element is controlled to be in the turn-off state, such that a corresponding slit opening 131 is in the turn-off state.

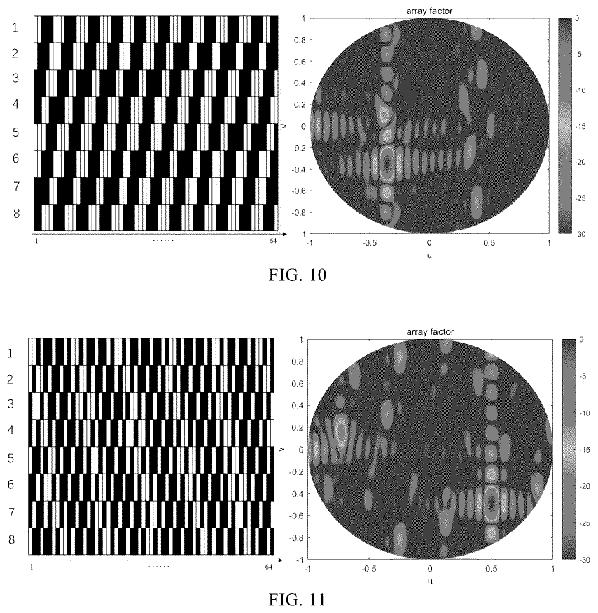

In addition, FIG. 7 is a simulation diagram illustrating a wavefront control distribution and a far field result of the antenna device at a beam pointing direction of (0°, 0°), in the first example according to an embodiment of the present disclosure; FIG. 8 is a simulation diagram illustrating a wavefront control distribution and a far field result of the antenna device at a beam pointing direction of (45°, 30°), in the first example according to the embodiment of the present disclosure; FIG. 9 is a simulation diagram illustrating a wavefront control distribution and a far field result of the antenna device at a beam pointing direction of (135°, 30°), in the first example according to the embodiment of the present disclosure; FIG. 10 is a simulation diagram illustrating a wavefront control distribution and a far field result of the antenna device at a beam pointing direction of (225°, 30°), in the first example according to the embodiment of the present disclosure; and FIG. 11 is a simulation diagram illustrating a wavefront sampling distribution and a far field result of the antenna device at a beam pointing direction of (315°, 45°), in the first example according to the embodiment of the present disclosure. Referring to FIGS. 6 to 11, diagrams illustrating the turn-on state, the turn-off state, and a far-field radiation pattern of the slit openings 131 arranged in an array are shown for the pitching angle and the azimuth angle of the target pointing direction being designed as (0°, 0°), (45°, 30°), (135°, 30°), (225°, 30°), and (315°, 45°). In the diagrams illustrating the turn-on state and the turn-off state of the slit openings 131 arranged in an array, black indicates that the slit openings 131 are in the turn-off state, and white indicates that the slit openings 131 are in the turn-on state.

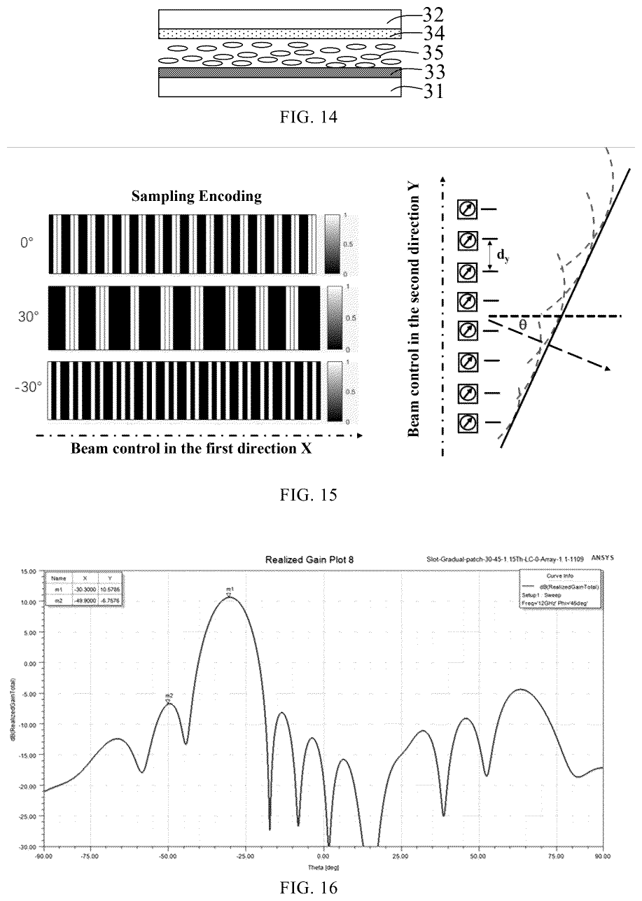

In a second example, FIG. 13 is a schematic diagram illustrating a structure of an antenna device in the second example according to an embodiment of the present disclosure. As shown in FIG. 13, the structure of the antenna device in the present example is substantially the same as the antenna device in the first example, except that in the antenna device in the second example, each branch feed channel 202 of the feed structure 20 is electrically connected to the corresponding antenna unit 10 through a phase adjustment structure 30. That is, the branch feed channels 202 are disposed in one-to-one correspondence with phase adjustment structures 30, and the branch feed channels 202, which are disposed in one-to-one correspondence with the phase adjustment structures 30, are electrically connected to the phase adjustment structures 30, respectively; the phase adjustment structures 30 are disposed in one-to-one correspondence with the antenna units 10, and the phase adjustment structures 30, which are disposed in one-to-one correspondence with the antenna units 10, are connected in one-to-one correspondence with the antenna units 10. In this case, since a phase adjustment structure 30 is disposed on each branch feed channel 202, the beam controlling in the first direction X can be realized through the phase adjustment structures 30, and it is only necessary to sample the slit openings 131, which are arranged in an array, in the first direction X by using the holographic algorithm. Then, the turn-on state and the turn-off state of the radiation element in each of the antenna units 10 is controlled, so as to realize the control of the turn-on state and the turn-off state of the slit opening 131, thereby realizing pointing directions of different beams. That is, in the present example, beam control throughout the entire space is achieved by combining dynamic beam scanning in the first direction X with dynamic beam scanning of the phase adjustment structures 30 in the first direction X.

FIG. 15 is a schematic diagram illustrating a beam control in the second direction Y and a beam control in the first direction X implemented by the antenna device shown in FIG. 13. Referring to FIG. 15, a schematic diagram illustrating the turn-on state and the turn-off state of the slit openings 131 of the antenna units 10 of the antenna device at 0°, 30°, and −30° in the first direction X are shown. In this figure, black indicates that the slit openings 131 are in the turn-off state, and white indicates that the slit openings 131 are in the turn-on state. A schematic diagram illustrating that an angle control in the second direction Y is realized by the phase control of the phase adjustment structures 30 in the second direction Y is given with reference to FIG. 13.

FIG. 16 is a simulation diagram illustrating a far field result of the antenna device shown in FIG. 13. Referring to FIG. 16, a far field diagram of a two-dimensional beam pointing direction simulation of a beam pointing direction (45°, 30°) is shown.

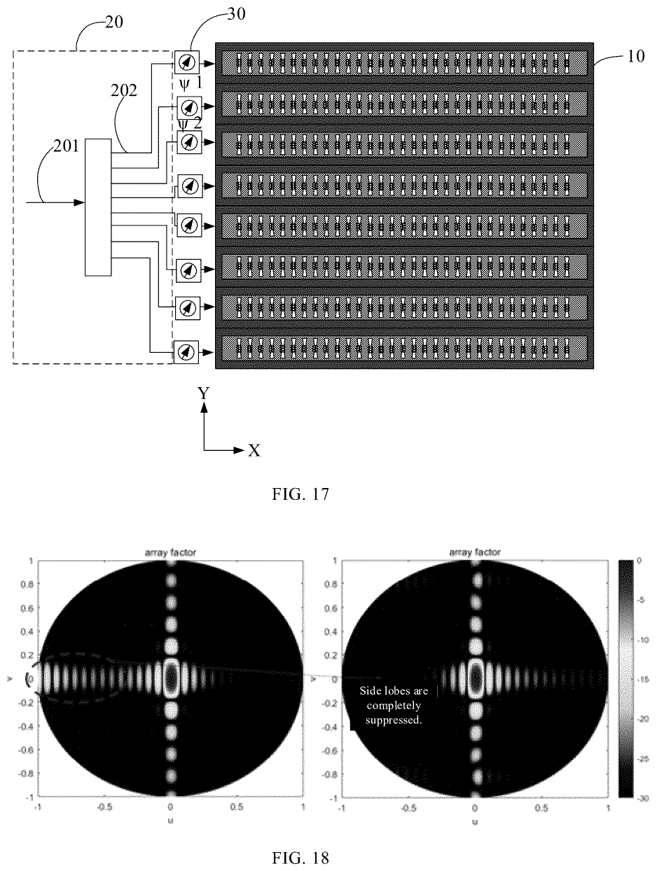

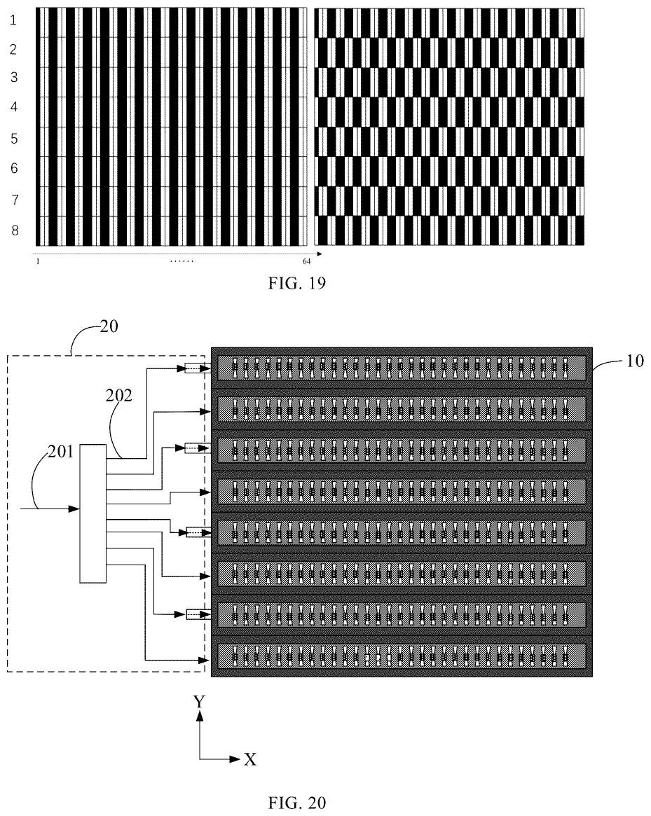

In an example, FIG. 17 is a schematic diagram illustrating another structure of the antenna device in the second example according to the embodiment of the present disclosure. As shown in FIG. 17, every adjacent two of the branch feed channels 202 of the feed structure 20 are grouped as one group, and the phase adjustment structures 30 connected to the two branch feed channels 202 in each group feed electromagnetic waves, which have therebetween a phase difference of 180° (e.g., Ψ1−Ψ2=180°), to the respective waveguide structures 11. That is, an initial phase difference between the microwave signals fed from the branch feed channels 202 in each group is 180°; for example, one of the microwave signals may have an initial phase of 180°, and the other of the microwave signals may have an initial phase of 0°. Further, in the feed structure 20, the initial phases of the electromagnetic waves output from the phase adjustment structures 30 electrically connected to odd-numbered branch feed channels 202 are equal to each other, and the initial phases of the electromagnetic waves output from the phase adjustment structures 30 electrically connected to even-numbered branch feed channels 202 are equal to each other. Referring to FIG. 18, a side lobe is greatly suppressed at a large angle position in an antenna device in which an initialized phase is differentiated, as compared with the case of a same initial phase. Referring to FIG. 19, it can be seen that wavefront sampling distributions are different for the case of a same initial phase and the case of different initial phases (the left side is the wavefront sampling distribution for the case of a same initial phase, and the right side is the wavefront sampling distribution for the case of differentiated initialization phases).

In some examples as shown in FIG. 14, exemplarily, each phase adjustment structure 30 according to an embodiment of the present disclosure may be a liquid crystal phase shifter. Specifically, the liquid crystal phase shifter may include a third dielectric substrate 31 and a fourth dielectric substrate 32 disposed opposite to each other, a third electrode layer 33 disposed on a side of the third dielectric substrate 31 proximal to the fourth dielectric substrate 32, a fourth electrode layer 34 disposed on a side of the fourth dielectric substrate 32 proximal to the third dielectric substrate 31, and a second adjustable dielectric layer 35 disposed between the third electrode layer 33 and the fourth electrode layer 34. The second adjustable dielectric layer 35 may be a liquid crystal layer. In this case, by controlling a bias voltage applied across the third electrode layer 33 and the fourth electrode layer 34, a dielectric constant of liquid crystal molecules of the liquid crystal layer is changed, thereby adjusting a phase of an electromagnetic wave. In an embodiment of the present disclosure, the fourth dielectric substrate 32 may be disposed on a side of the waveguide structure distal to the first dielectric substrate.

Further, each phase adjustment structure 30 according to an embodiment of the present disclosure is not limited to the liquid crystal phase shifter, and may alternatively be any phase adjustment structure such as a digital phase shifter, a fixed phase shifter, and the like, which are not listed exhaustively here.

In a third example, FIG. 20 is a schematic diagram illustrating a structure of an antenna device in a third example according to an embodiment of the present disclosure. As shown in FIG. 20, the structure of the antenna device in the third example is substantially the same as that in the first example, except that in the antenna device in the third example, every adjacent two of the branch feed channels 202 of the feed structure 20 are grouped as one group, and lengths of the two branch feed channels 202 in each group are not equal to each other. In particular, the lengths of the two branch feed channels 202 in each group are set such that the electromagnetic waves fed from the two branch feed channels 202 into the respective waveguide structures 11 have a phase difference of 180°. That is, by setting the initial phase difference between any adjacent two of the branch feed channels 202 to be 180°, the effect of suppressing a side lobe in a large angle range is achieved. The principle of this structure is the same as that of the structure in the second example as shown in FIG. 13 and FIG. 17, except that the phase adjustment structures 30 are not required in the third example, and the same effect can be achieved by merely setting the lengths of the branch feed channels 202.

Further, in the feed structure 20, the lengths of the odd-numbered branch feed channels 202 are equal to each other, and the lengths of the even-numbered branch feed channels 202 are equal to each other. In this case, the branch feed channels 202 can be configured easily.

In a fourth example, the structure of the antenna device in this example is substantially the same as that in the first example, except that in the antenna device in the fourth example, every adjacent two of the branch feed channels 202 of the feed structure 20 are grouped as one group, and media filled in the two branch feed channels 202 in each group are different from each other. The media filled in the two branch feed channels 202 in each group are provided such that the electromagnetic waves fed from the two branch feed channels 202 into the corresponding waveguide structures 11 have a phase difference of 180°. That is, a difference between the initial phases of any adjacent two of the branch feed channels 202 is set to be 180° by adding materials having different dielectric constants into the any adjacent two of the branch feed channels 202, respectively, so as to achieve the effect of suppressing a side lobe in a large angle range.

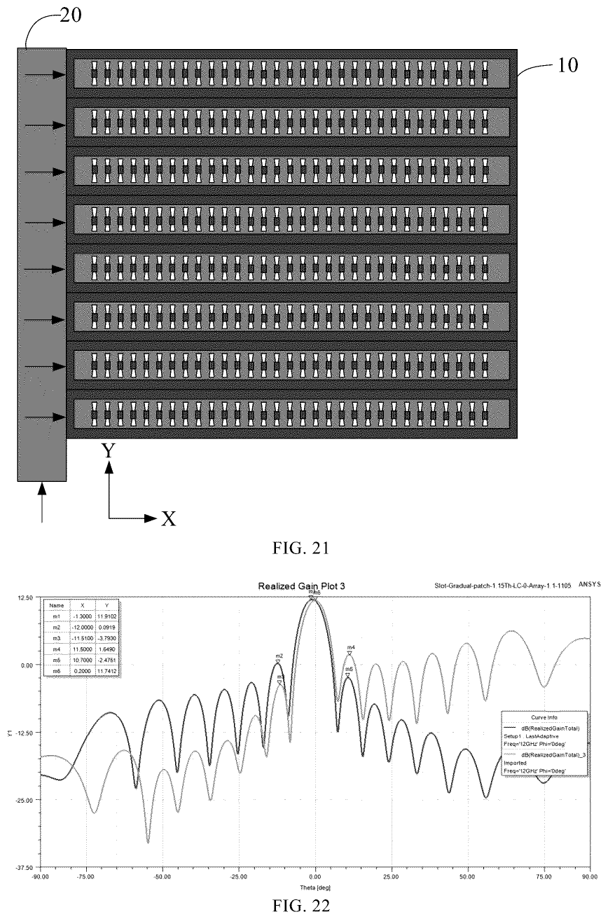

In a fifth example, FIG. 21 is a schematic diagram illustrating a structure of an antenna device in a fifth example according to an embodiment of the present disclosure. As shown in FIG. 21, a feed structure 20 of the antenna device in the fifth example is different from the feed structure 20 in each of the foregoing four examples. The feed structure 20 in the fifth example adopts a structure of a single feed channel, and for example, is a single waveguide structure, which has a first feed port, and eight second feed ports arranged side by side along the first direction X. The eight second feed ports have different distances from the first feed port, and thus the initial phases of the electromagnetic wave signals fed from the eight second feed ports into the corresponding waveguide structures 11 are different from each other.

In an example, a distance between any adjacent two of the second feed ports is provided such that the electromagnetic wave signals fed from the any adjacent two of the second feed ports into the respective waveguide structures 11 have an initial phase difference of 180°. That is, the initial phase difference of any adjacent two of the second feed ports is 180°, thereby achieving the effect of suppressing a side lobe in a large angle range. Reference may be made to FIG. 22, which is a diagram illustrating a simulation effect of side lobe suppression of the antenna device shown in FIG. 21.

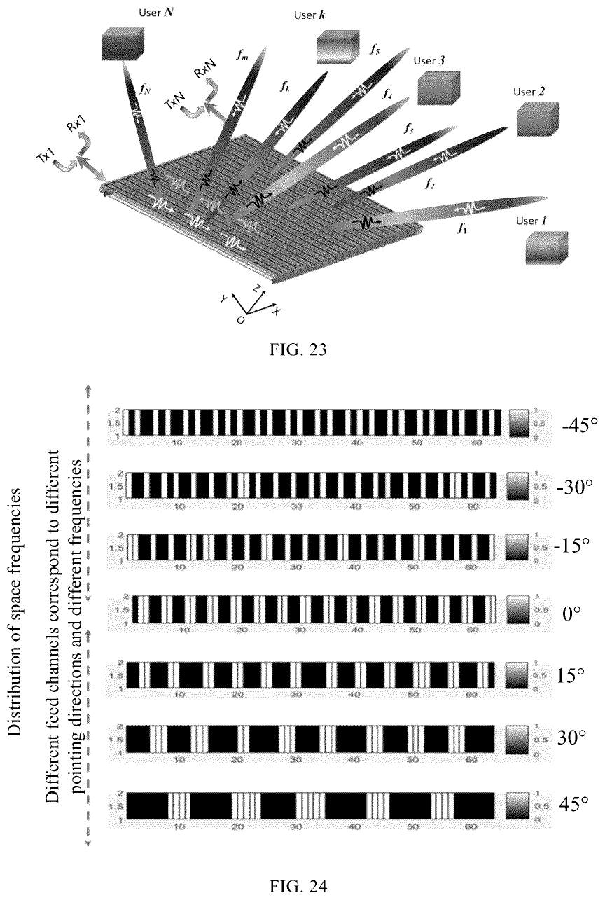

In a sixth example, FIG. 23 is diagram illustrating a multi-user interaction effect of an antenna device in a sixth example according to an embodiment of the present disclosure. As shown in FIG. 23, a feed structure 20 of the antenna device in the sixth example is different from the feed structure 20 in each of the foregoing five examples in that the feed structure 20 in the sixth example includes a plurality of independent feed channels, each of which has a first terminal and a second terminal, the first terminal of each feed channel serves as one first feed port of the feed structure 20, and the second terminal of each feed channel serves as one second feed port of the feed structure 20. That is, each antenna unit 10 of the antenna device is fed with a signal by one of the feed channels. In this structure, since each antenna unit 10 is provided with an independent feed channel, different frequencies can be input to different channels, and beam scanning can be performed at different frequencies.

In some examples, the antenna device may be a transceiver antenna, i.e., the antenna device can both transmit and receive an electromagnetic wave signal. Apparently, in addition to the above structure, the antenna device may further include a transceiver unit, a radio frequency transceiver, a signal amplifier, a power amplifier, and/or a filtering unit. An antenna in a communication device may serve as a transmitting antenna or as a receiving antenna. The transceiver unit may include a baseband and a receiving terminal, where the baseband provides signals of at least one frequency band, for example, provides 2G signals, 3G signals, 4G signals, 5G signals, and/or the like, and sends the signals of at least one frequency band to the radio frequency transceiver. After receiving a signal by the antenna in a communication system, the signal may be processed by the filtering unit, the power amplifier, the signal amplifier, and the radio frequency transceiver, and then the antenna in the communication system may transmit the signal to a receiving terminal in the transceiver unit, where the receiving terminal may be, for example, an intelligent gateway.

Further, the radio frequency transceiver is connected to the transceiver unit, and is configured to modulate a signal sent by the transceiver unit, or to demodulate a signal received by the antenna and transmit the modulated signal to the transceiver unit. Specifically, the radio frequency transceiver may include a transmitting circuit, a receiving circuit, a modulating circuit, and a demodulating circuit. After the transmitting circuit receives signals of multiple types provided by the baseband, the modulating circuit may modulate the signals of multiple types provided by the baseband and then send the signals to the antenna. The antenna receives the signals and transmits the signals to the receiving circuit of the radio frequency transceiver, the receiving circuit transmits the signals to the demodulating circuit, and the demodulating circuit demodulates the signals and transmits the demodulated signals to the receiving terminal.

Further, the radio frequency transceiver is connected to the signal amplifier and the power amplifier which are further connected to the filtering unit, and the filtering unit is connected to at least one antenna. During a process of sending a signal by the communication system, the signal amplifier increases a signal-to-noise ratio of the signal output from the radio frequency transceiver and then transmits the signal to the filtering unit; the power amplifier amplifies the power of the signal output from the radio frequency transceiver and then transmits the signal to the filtering unit; the filtering unit may exemplarily include a duplexer and a filtering circuit, the filtering unit combines the signals output from the signal amplifier and the power amplifier, filters out noise waves from the combined signal, and then transmits the combined signal to the antenna; and the antenna radiates the signal outward. During a process of receiving a signal by the communication system, the antenna receives the signal and transmits the signal to the filtering unit; the filtering unit filters out noise waves from the signal received by the antenna, and transmits the signal to the signal amplifier and the power amplifier; the signal amplifier gains the signal received by the antenna to increase the signal-to-noise ratio of the signal; and the power amplifier amplifies the power of the signal received by the antenna. The signal received by the antenna is processed by the power amplifier and the signal amplifier, and then transmitted to the radio frequency transceiver; and the radio frequency transceiver transmits the signal to the transceiver unit.

In some examples, the signal amplifier may include any one of signal amplifiers of various types, such as a low noise amplifier, but the present disclosure is not limited thereto.

In some examples, the antenna device according to an embodiment of the present disclosure further includes a power management unit, which is connected to the power amplifier and provides the power amplifier with a voltage for amplifying a signal.

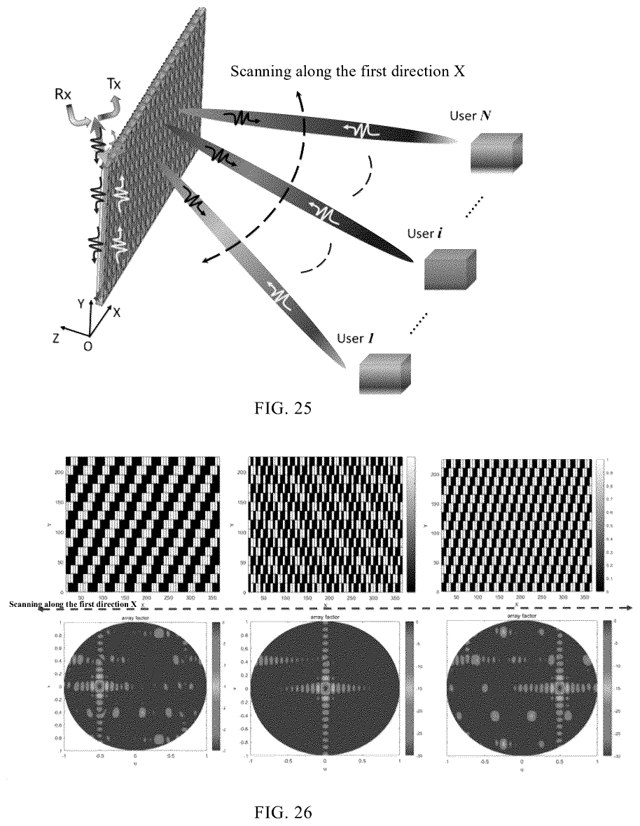

For the antenna device in the present example, each antenna unit 10 is fed with a signal by an independent feed channel, each antenna transmits a signal at a different frequency, and each holographic beam dynamic control antenna can implement beam scanning in a space, thereby implementing multi-user interactive communication of space-frequency distribution, as shown in FIG. 23. Inputting electromagnetic waves with different frequencies from different feed channels corresponds to beam scanning for different frequencies. FIG. 24 is a diagram illustrating a distribution of space frequencies of the antenna device shown in FIG. 23 in a case where different feed channels correspond to different pointing directions and different frequencies. As shown in FIG. 24, the antenna units 10 correspond to different encoding states of different frequencies and beam pointing directions, wherein black indicates that the slit openings 131 are in the turn-off state, and white indicates that the slit openings 131 are in the turn-on state.

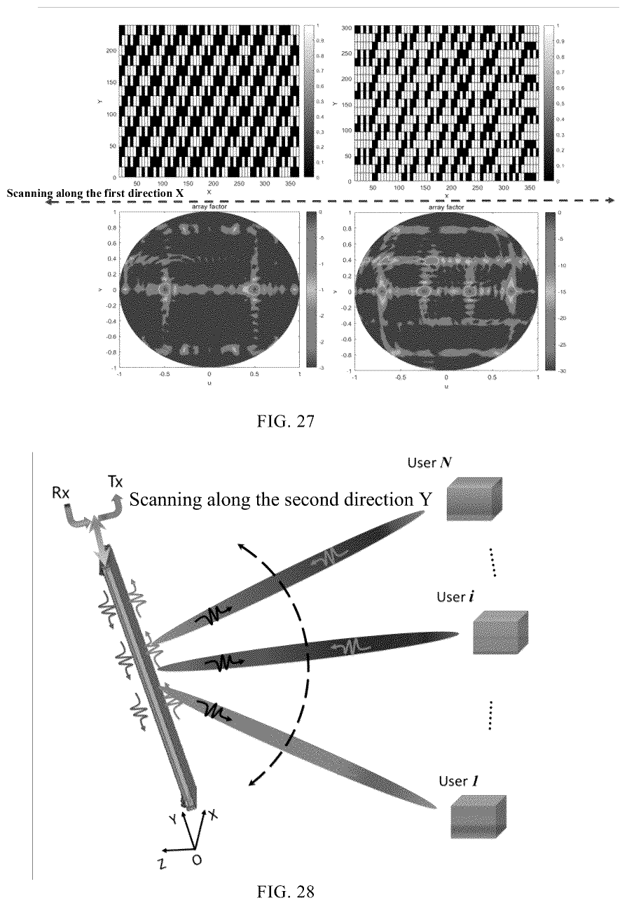

In the antenna device in any one of the foregoing six examples according to the embodiments of the present disclosure, each antenna unit 10 may be a transmitting antenna, a receiving antenna, or a transceiver antenna. FIG. 25 is a diagram illustrating an interaction effect between the antenna device according to an embodiment of the present disclosure and a plurality of users when the antenna device implements scanning in the first direction X. Referring to FIG. 25, by controlling the turn-on state and the turn-off state of the slit openings 131 of the antenna units 10, beam scanning in the first direction X can be achieved. Each beam is directed to one of target users (User 1 . . . User i . . . User N), thereby achieving interactive communication between users at different locations on the ground. Results of a single beam scanning and a multi-beam scanning in the first direction X are shown in FIG. 26 and FIG. 27, where FIG. 26 is a diagram illustrating a wavefront distribution and a far field result of a single beam scanning in the first direction X implemented by the antenna device according to an embodiment of the present disclosure, and FIG. 27 is a diagram illustrating a wavefront distribution and a far field result of a multi-beam scanning in the first direction X implemented by the antenna device according to an embodiment of the present disclosure.

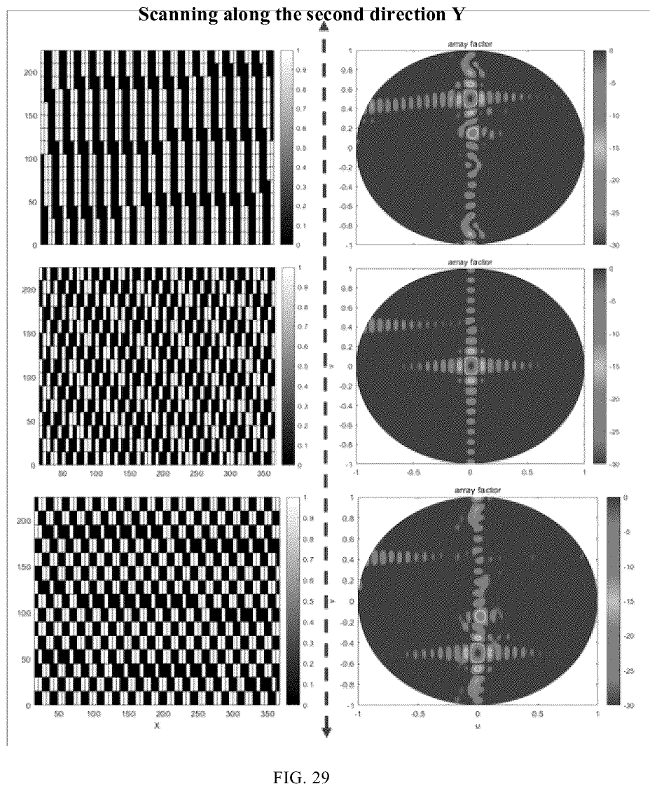

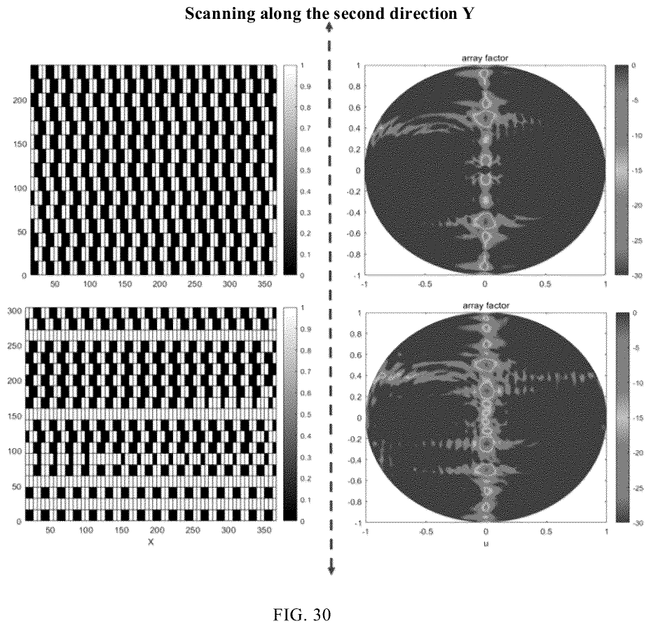

FIG. 28 is a diagram illustrating an interaction effect between the antenna device according to an embodiment of the present disclosure and a plurality of users when the antenna device implements scanning in the second direction Y. As shown in FIG. 28, by controlling the turn-on state and the turn-off state of the slit openings 131 of the antenna units 10, beam scanning in the second direction Y can also be achieved. Each beam is directed to a target user, thereby achieving interactive communication of users at different locations on the ground. Results of a single beam scanning and a multi-beam scanning in the second direction Y are shown in FIG. 29 and FIG. 30, where FIG. 29 is a diagram illustrating a wavefront distribution and a far field result of a single beam scanning in the second direction Y implemented by the antenna device according to an embodiment of the present disclosure, and FIG. 30 is a diagram illustrating a wavefront distribution and a far field result of a multi-beam scanning in the second direction Y implemented by the antenna device according to an embodiment of the present disclosure.

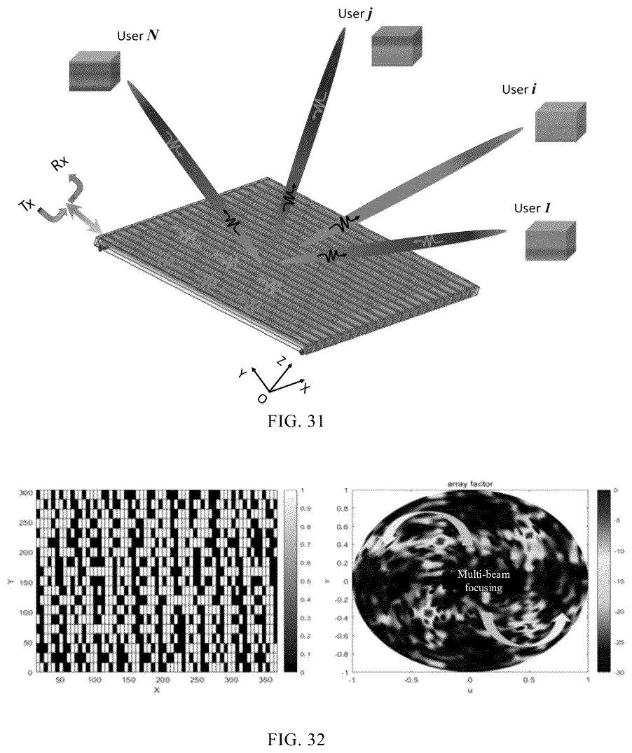

Further, FIG. 31 is a diagram illustrating an interaction effect between the antenna device according to an embodiment of the present disclosure and a plurality of users when the antenna device implements a scanning in a plane defined by the second direction Y and the first direction X. As shown in FIG. 31, by controlling the turn-on state and the turn-off state of the slit openings 131 of the antenna units 10, beam scanning in the plane defined by the second direction Y and the first direction X can also be achieved. Each beam points to a target user, thereby achieving interactive communication between users in a spatial range. A result of a beam spatial scanning in the plane defined by the second direction Y and the first direction X is shown in FIG. 32. FIG. 32 is a diagram illustrating a wavefront distribution and a far field result of the scanning in the plane defined by the second direction Y and the first direction X implemented by the antenna device according to an embodiment of the present disclosure.

It will be understood that the foregoing embodiments are merely exemplary embodiments adopted to illustrate the principles of the present disclosure, and the present disclosure is not limited thereto. It will be apparent to one of ordinary skill in the art that various modifications and improvements may be made therein without departing from the spirit and scope of the present disclosure, and such modifications and improvements are also considered to be within the scope of the present disclosure.

1. An antenna device, comprising a plurality of antenna units arranged side by side in a second direction, wherein each of the plurality of antenna units comprises a waveguide structure and a radiation structure; the radiation structure comprises a first dielectric substrate and a second dielectric substrate which are opposite to each other, a first electrode layer arranged on a side of the first dielectric substrate proximal to the second dielectric substrate, a second electrode layer arranged on a side of the second dielectric substrate proximal to the first dielectric substrate, and a first adjustable dielectric layer arranged between the first dielectric substrate and the second dielectric substrate; the first dielectric substrate is arranged on a waveguide cavity of the waveguide structure; the first electrode layer has therein a plurality of slit openings arranged side by side along a first direction, and the second electrode layer comprises a plurality of patch electrodes spaced apart from each other; an orthogonal projection of each of the plurality of patch electrodes on the first dielectric substrate at least partially overlaps with an orthogonal projection of one of the plurality of slit openings on the first dielectric substrate; and
wherein the antenna device further comprises a feed structure, the feed structure comprises at least one first feed port and a plurality of second feed ports, and each of the plurality of second feed ports is electrically connected to the waveguide structure of one of the plurality of antenna units.

2. The antenna device according to claim 1, wherein the feed structure comprises a main feed channel and a plurality of branch feed channels, each of the main feed channel and the plurality of branch feed channels has a first terminal and a second terminal, the first terminal of the main feed channel serves as the first feed port, first terminals of the branch feed channels are all connected to the second terminal of the main feed channel, and second terminals of the branch feed channels serve as the second feed ports, respectively.

3. The antenna device according to claim 2, further comprising a plurality of phase adjustment structures, wherein each of the branch feed channels is electrically connected to the waveguide structure of one of the antenna units through one of the phase adjustment structures.

4. The antenna device according to claim 3, wherein each of the phase adjustment structures comprises a liquid crystal phase shifter.

5. The antenna device according to claim 2, wherein at least some of the branch feed channels have different lengths.

6. The antenna device according to claim 5, wherein every adjacent two of the branch feed channels are grouped as one group, and the two branch feed channels in each group have different lengths.

7. The antenna device according to claim 6, wherein the lengths of the two branch feed channels in each group are set such that electromagnetic waves fed from the two branch feed channels into the respective waveguide structures have a phase difference of 180°.

8. The antenna device according to claim 2, wherein the plurality of branch feed channels have a same length, and at least some of the plurality of branch feed channels are filled with different media.

9. The antenna device according to claim 8, wherein every adjacent two of the branch feed channels are grouped as one group, and the two branch feed channels in each group are filled with different media.

10. The antenna device according to claim 9, wherein the media filled in the two branch feed channels in each group are provided such that electromagnetic waves fed from the two branch feed channels into the respective waveguide structures have a phase difference of 180°.

11. The antenna device according to claim 1, wherein the plurality of second feed ports of the feed structure feed electromagnetic waves, which have different phases from each other, into the respective waveguide structures.

12. The antenna device according to claim 1, wherein any adjacent two of the second feed ports feed electromagnetic waves, which have a phase difference of 180°, into the respective waveguide structures.

13. The antenna device according to claim 1, wherein the feed structure comprises a plurality of feed channels, each of which has a first terminal and a second terminal, the first terminal of one of the feed channels serves as one of the at least one first feed port of the feed structure, and the second terminal of each feed channel serves as one of the second feed ports of the feed structure.

14. The antenna device according to claim 1, wherein the first electrode layer is connected to a first bias voltage line, each of the patch electrodes is connected to a second bias voltage line, and the patch electrodes are connected to separate second bias voltage lines.

15. The antenna device according to claim 1, wherein the slit openings of the antenna units are arranged in a one-to-one correspondence; the first electrode layer is connected to a first bias voltage line, each of the patch electrodes is connected to a second bias voltage line; and the patch electrodes arranged side by side along the second direction are connected to a same second bias voltage line.

16. The antenna device according to claim 14, further comprising a driver chip, wherein both each first bias voltage line and each second bias voltage line are electrically connected to the driver chip.

17. The antenna device according to claim 1, wherein a width of a central region of each slit opening is not greater than a width of each of both end regions of the slit opening.

18. The antenna device according to claim 17, wherein the width of each of the both end regions of the slit opening is decreased in a direction toward the central region.

19. A beam control method for an antenna device, wherein the antenna device is the antenna device according to claim 1, and the beam control method comprises:
obtaining excitation amplitude values of the slit openings through an amplitude sampling function, according to positions of the slit openings of each antenna unit, a pitching angle and an azimuth angle of a target pointing direction, and target frequencies of electromagnetic waves fed from the second feed ports of the feed structure into the waveguide structures of the respective antenna units;
discretizing the excitation amplitude values of the slit openings to obtain discretization results; and
controlling radiation elements according to the discretization results so as to control a turn-on state and a turn-off state of the slit openings.

20. The beam control method according to claim 19, wherein the feed structure comprises a plurality of feed channels, each of which has a first terminal and a second terminal, the first terminal of one of the feed channels serves as one of the at least one first feed port of the feed structure, and the second terminal of each feed channel serves as one of the second feed ports of the feed structure; and
at least some of the feed channels feed electromagnetic waves, which have different frequencies, into the waveguide structures of the antenna units connected to the at least some of the feed channels.
